(19) United States
(12) Patent Application Publication
(10) Pub. No.: US 2024/0218890 A1
(43) Pub. Date: Jul. 4, 2024

(54) RELIEF PRESSURE CONTROL DEVICE

(71) Applicant: Caterpillar SARL, Geneva (CH)

(72) Inventors: Hideki NAKAJIMA, Akashi-shi (JP); Shino SAKO, Akashi-shi (JP)

(73) Assignee: Caterpillar SARL, Geneva (CH)

(21) Appl. No.: 18/293,482

(22) PCT Filed: Aug. 15, 2022
(86) PCT No.: PCT/EP2022/025378

§ 371 Date: Jan. 30, 2024

(30) Foreign Application Priority Data
Aug. 18, 2021 (JP) 2021-133218

(51) Int. Cl. F15B 20/00; F15B 21/08

(52) U.S. Cl. CPC F15B 20/007; F15B 21/08; F15B 2211/50518; F15B 2211/526; F15B 2211/55; F15B 2211/6653

(57) ABSTRACT

To provide a relief pressure control device in which a relief pressure can be set easily, and further power consumption is suppressed. A relief pressure control device is equipped with a relief valve in which a setting pressure is made variable as a function of an energization quantity, and a controller configured to set at least one relief pressure of a fluid pressure circuit by controlling the energization quantity of the relief valve. The controller energizes the relief valve, when the pump pressure exceeds a predetermined threshold pressure lower than the setting pressure of the relief valve that is in its non-energized state.

### FIELD OF THE INVENTION

The present invention relates to a relief pressure control device configured to control a relief pressure of a fluid pressure circuit.

### BACKGROUND OF THE INVENTION

Conventionally, in a hydraulic circuit system which is a fluid pressure circuit used in a work machine or the like, a main relief valve is provided serving as a control valve, thereby generally limiting an excessive pressure rise of the system.

It may be effectual if multiple relief pressures of a hydraulic system could be set depending on use application. For example, it is effectual if relief pressures could be set differently between traveling and operation of work equipment, or between normal mode and lifting work mode (heavy lift mode).

In this regard, it is conceivable to use a relief valve in which setting pressures can be switched to two stages. Generally, a two-stage regulatable type main relief valve or an on/off valve is used.

However, there is a problem that, when these valves are used, regulation such as the necessity for pressure regulation work over a plurality of times becomes laborious, as well as component configuration and system configuration also become complicated.

In this regard, by using an electromagnetic relief valve in which a setting pressure can be set as a function of an energization quantity to make the setting pressure of the electromagnetic relief valve regulatable in response to a signal from a controller, an electromagnetic relief valve that is made switchable to a plurality of relief pressures is known (see, for example, Patent Literatures 1 to 4).

### PRIOR ART LITERATURES

### Patent Literatures

PATENT LITERATURE 1 Japanese Patent No. 2732922
PATENT LITERATURE 2 Japanese Patent No. 4458083
PATENT LITERATURE 3 Japanese Patent No. 6347936
PATENT LITERATURE 4 Japanese Patent Application Laid-Open No. 1995-36548

### SUMMARY OF THE INVENTION

### Problems to be Solved by the Invention

In a hydraulic circuit system using an electromagnetic relief valve as described above, it is desired to suppress power consumption.

The present invention has been made in view of the above situation, and it is an object of the present invention to provide a relief pressure control device in which a relief pressure can be set easily, and power consumption can be suppressed.

### Means for Solving the Problem

An invention described in claim 1 is a relief pressure control device configured to control a relief pressure of a fluid pressure circuit, the relief pressure control device comprising: an electromagnetic relief valve in which a setting pressure is set larger as an energization quantity is larger; and a controller configured to set at least one relief pressure of a fluid pressure circuit by controlling the energization quantity of the electromagnetic relief valve, wherein the controller energizes the electromagnetic relief valve, when a pump pressure exceeds a predetermined threshold pressure lower than the setting pressure of the electromagnetic relief valve that is in its non-energized state.

An invention described in claim 2 is the relief pressure control device according to claim 1, wherein the predetermined threshold pressure is set in accordance with a pressure at which pre-leakage occurs in the electromagnetic relief valve that is in its non-energized state.

An invention described in claim 3 is the relief pressure control device according to claim 1, wherein the controller sets the energization quantity of the electromagnetic relief valve to a first predetermined value, when the pump pressure exceeds a first predetermined threshold pressure lower than the setting pressure of the electromagnetic relief valve that is in its non-energized state, and the controller sets the energization quantity of the electromagnetic relief valve to a second predetermined value larger than the first predetermined value, when the pump pressure is smaller than the first predetermined threshold pressure and exceeds a second predetermined threshold pressure that is set in accordance with a pressure at which the pre-leakage occurs in the electromagnetic relief valve that is in its non-energized state.

### Favorable Effects of the Invention

According to the invention described in claim 1, the relief pressure can be easily set as a function of the energization quantity supplied from the controller, and further power consumption can be reduced by making the electromagnetic relief valve non-energized in normal times and making the electromagnetic relief valve energized from the controller only when the pump pressure reaches a high pressure.

According to the invention described in claim 2, energy loss caused by the pre-leakage can be suppressed, and further the relief pressure can be prevented from becoming lower than desired due to the pre-leakage.

According to the invention described in claim 3, the relief pressure can be easily set with a minimum energization quantity, while preventing the pre-leakage by setting the setting pressure to the high pressure until immediately before the pump pressure reaches the first predetermined threshold pressure.

### BRIEF DESCRIPTION OF THE DRAWINGS

FIG. 1 is a circuit diagram showing a first embodiment of a relief pressure control device according to the present invention.

FIG. 2 is a graph showing an example of energization quantity/setting pressure characteristic of an electromagnetic relief valve of the relief pressure control device as above.

FIG. 3 is a graph illustrating a method of calibrating the energization quantity of the electromagnetic relief valve of the relief pressure control device as above.

FIG. 4(a) is a graph showing an example of pump pressure change with time during operation of the relief pressure control device as above; and FIG. 4(b) is a graph showing an example of a control of an energization quantity of the electromagnetic relief valve corresponding to FIG. 4(a).

FIG. 5 is a graph showing an example of the characteristics of an electromagnetic relief valve of a second embodiment of the relief pressure control device according to the present invention.

FIG. 6 is a graph illustrating a method of calibrating the energization quantity of the electromagnetic relief valve of the relief pressure control device as above.

FIG. 7(a) is a graph showing an example of pump pressure change with time during operation of the relief pressure control device as above; FIG. 7(b) is a graph showing an example of a control of an energization quantity of the electromagnetic relief valve corresponding to FIG. 7(a); and FIG. 7(c) is a graph showing a flow rate change with time of the electromagnetic relief valve according to FIG. 7(b).

### DETAILED DESCRIPTION OF THE INVENTION

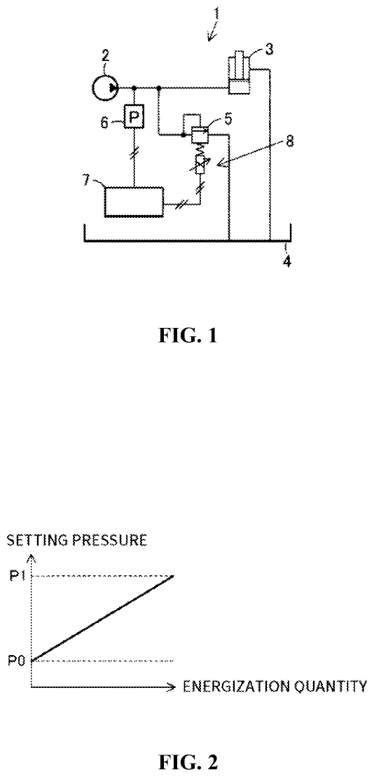

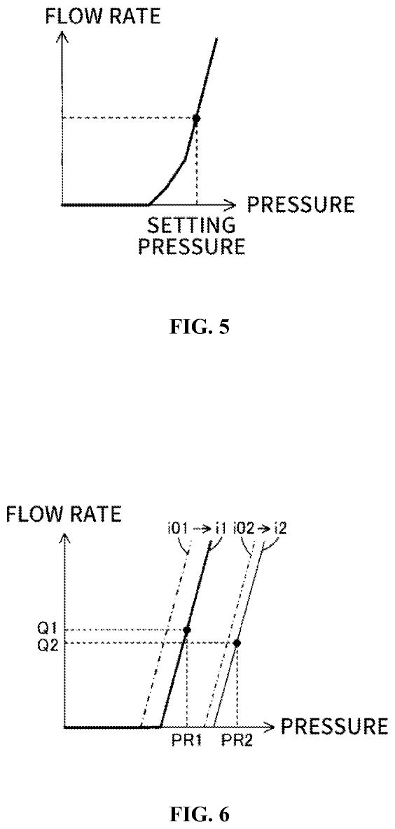

Hereinbelow, the present invention will be described in detail based on a first embodiment shown in FIGS. 1 to 4 and a second embodiment shown in FIGS. 5 to 7.

First, the first embodiment will be described.

In FIG. 1, reference numeral 1 denotes a fluid pressure circuit. The fluid pressure circuit 1 comprises a pump 2. The pump 2 is operated by a prime mover such as an engine or a motor, and supplies working fluid to the fluid pressure circuit 1. That is, the pump 2 converts mechanical power into fluid pressure power. The fluid pressure power converted by the pump 2 is converted into mechanical power by a fluid pressure actuator 3. An optional number of the fluid pressure actuators 3 of optional type may be used. In FIG. 1, the fluid pressure actuator 3 is shown taking one fluid pressure cylinder as an example. Further, the working fluid supplied into the fluid pressure circuit 1 by the pump 2 is stored in a tank 4. The tank 4 receives return fluid of the fluid pressure circuit 1.

The fluid pressure circuit 1 is configured to actuate the fluid pressure actuator 3 to obtain power, by controlling the flow rate and direction of the working fluid supplied from the pump 2 operated by the prime mover to the fluid pressure actuator 3, by a control valve (not shown) in response to a lever operation and so on by an operator.

In the present embodiment, the fluid pressure circuit 1 is a hydraulic circuit used for a work machine such as a hydraulic excavator. In this case, the fluid pressure actuator 3 is used for traveling and revolving of the work machine, or for actuations of a work equipment composed of a boom, an arm, a bucket, and the like.

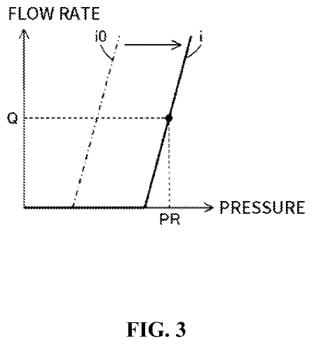

The upper limit of the pump pressure being the circuit pressure of the fluid pressure circuit 1, that is, the relief pressure is set by a relief valve 5. The relief valve 5 is connected to a discharge passage of the pump 2 and is set to allow a part of the working fluid to escape to the tank 4. In the present embodiment, the relief valve 5 is an electromagnetic relief valve, i.e., an electromagnetic variable relief valve, in which the setting pressure is made variable as a function of the energization quantity. The relief valve 5 is configured so that the setting pressure increases as the energization quantity increases. In the present embodiment, the relief valve 5 is a proportional electromagnetic relief valve in which a setting pressure changes in proportion to an energization quantity to the solenoid (input current). FIG. 2 shows an example of energization quantity (input current)/setting pressure characteristic of the relief valve 5. In the illustrated example, the setting pressure of the relief valve 5 (FIG. 1) increases linearly or substantially linearly from a setting pressure P0 in its non-energized state to a maximum setting pressure P1 with increasing in the energization quantity.

Further, as shown in FIG. 1, the energization quantity of the relief valve 5 is electronically controlled by a controller (ECM) 7 according to the output of a pressure sensor 6 that detects the pump pressure. The controller 7 is electrically connected with solenoids of the pressure sensor 6 and the relief valve 5, respectively. Then, the controller 7 sets at least one upper limit (system pressure) of the circuit pressure which is the relief pressure of the fluid pressure circuit 1, by using the setting pressure of the relief valve 5 that is set as a function of the energization quantity, by outputting a control signal for controlling the energization quantity to the relief valve 5. A relief pressure control device 8 is configured by the controller 7 and the relief valve 5.

The detailed configuration of other valves, filters, sensors, etc. of the fluid pressure circuit 1 is omitted for the sake of clarity of description.

Next, action of the illustrated embodiment will be described.

In the present embodiment, by using the relief valve 5 having a certain degree of setting pressure even in its non-energized state, the relief valve 5 is brought into the non-energized state in normal time and energized from the controller 7 to let the pump pressure escape only when the pump pressure rises.

When the relief pressure, which is the upper limit of the circuit pressure (system pressure) of the fluid pressure circuit 1, is set as a function of the energization quantity of the relief valve 5, a required energization quantity of the relief valve 5 varies depending on actual performance of the relief valve 5 and individual differences of work machines, etc., and therefore calibration is performed in advance.

At the time of this calibration, an engine horsepower is set to the maximum output, and further the fluid pressure actuator 3 is put into a maximum load state by the lever, and the energization quantity of the solenoid of the relief valve 5 by the controller 7 is set to a predetermined energization quantity. For example, the use of a boom cylinder as the fluid pressure actuator 3 brings into a state with the lever of being maintained at a position where the boom is raised maximally up to an operating limit, that is, at a position where the boom cylinder is extended to the maximum, that is, a boom lifted stall state.

In this state, as an example is shown in FIG. 3, an energization quantity i of the relief valve 5 (FIG. 1) is gradually increased (made to sweep) from a predetermined energization quantity i0 from the controller 7 (FIG. 1). An energization quantity i is recorded when the pump pressure detected by the pressure sensor 6 (FIG. 1) becomes a target pressure PR at a predetermined set flow rate Q of the relief valve 5 (FIG. 1). The predetermined energization quantity i0 may be any given small energization quantity, but is set to 0, for example. Further, the predetermined set flow rate Q is a maximum flow rate that can be discharged by the pump 2 with a pressure PR, which is a value determined depending on a horsepower curve of the work machine or the like, and further is a value that varies from machine to machine.

After that, the energization quantity i of the relief valve 5 is again set to the predetermined energization quantity i0 from the controller 7, and the energization quantity i of the relief valve 5 is gradually increased from the controller 7, then the energization quantity i is recorded when the pump pressure detected by the pressure sensor 6 at the predetermined set flow rate Q of the relief valve 5 becomes the target pressure PR. This operation is repeated a predetermined number of times, and an average value of the energization quantities i recorded for each time is registered in the controller 7 as a predetermined value ia corresponding to the relief pressure.

By performing the above-described calibration before shipping the work machine or the like, it is possible to set the energization quantity corresponding to dispersion of each machine in advance.

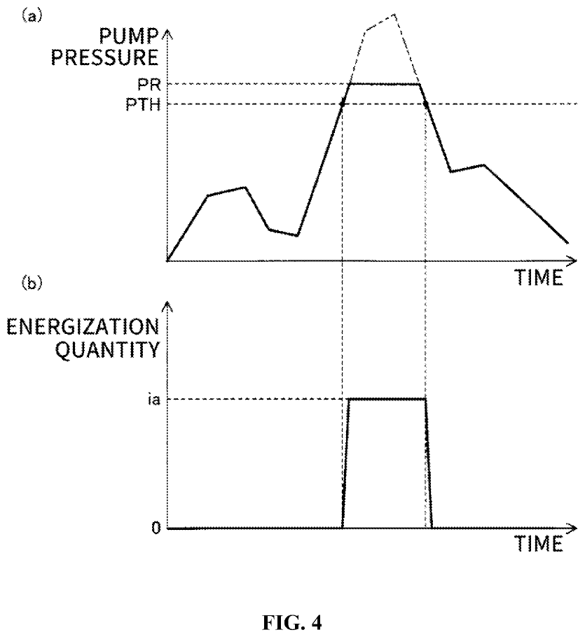

Then, for example, when the pump pressure changes with time as shown in FIG. 4(a), the controller 7 is basically not energizing the relief valve 5, and only when the pump pressure exceeds a predetermined threshold pressure PTH, the energization quantity of the relief valve 5 is set to the predetermined value ia as shown in FIG. 4(b), and the controller 7 energizes the relief valve 5. This enables the relief valve 5 to be opened so that a part of the working fluid is released to the tank 4, thereby limiting the system pressure of the fluid pressure circuit 1 to a predetermined pressure PR, and thus suppressing an excessive increase in the system pressure.

As described above, according to the first embodiment, when the pump pressure exceeds the predetermined threshold pressure lower than the setting pressure of the relief valve 5 that is in its non-energized state, the relief pressure can be easily set by energizing the relief valve 5 by the controller 7. In other words, if the relief pressure is set mechanically by a general relief valve, it is set when the setting pressure rises by pressure regulation, in accordance with the setting pressure-flow rate characteristic (PQ curve) that differs depending on models (horsepower) of work machines or the like, the set flow rate decreases, and further the setting pressure-flow rate characteristic has large variances depending on machines as well, which makes manual regulation laborious. On the other hand, in the present embodiment, by energizing the relief valve 5 from the controller 7 with an energization quantity that can be easily set for each machine by calibration, the relief pressure can be set easily and highly accurately, without the need for pressure regulation work and without occurrence of variations depending on machines.

Furthermore, since the relief valve 5 can be non-energized in normal times and the relief valve 5 can be energized only when the pump pressure reaches a high pressure, the power consumption can be suppressed.

In particular, since a pressure as high as the relief pressure is rarely required during the operation of the work machine or the like, actual energization time of the relief valve 5 can be significantly suppressed by appropriately setting a predetermined threshold pressure.

Further, since the setting pressure of the relief valve 5 can be set by switching between energization and non-energization, no manpower is required for pressure regulation work of the setting pressure of the relief valve 5, and the need to consider difference or variation of the set flow rate of the relief valve 5 for each machine can be eliminated by the calibration. Furthermore, since the relief pressure corresponding to different work modes can be set by selecting the relief valve 5 and setting the energization quantity to the relief valve 5 without varying the configuration depending on the difference in the specification of the work machine having different work modes, circuit components corresponding to specifications are not required and thus the number of circuit components can be reduced, inexpensive configuration can be achieved. Besides, differences in configurations due to differences specifications of work machines, etc. can be eliminated, and the risk of working fluid leakage can be also reduced.

In the first embodiment, one predetermined threshold pressure is set, but the present invention is not limited to this, and a plurality of predetermined threshold pressures different from each other may be set. Even in that case, by performing calibration for each threshold pressure similarly to the first embodiment, it becomes possible to set the energization quantities of the relief valve 5 that correspond to a plurality of predetermined threshold pressures respectively.

For example, as in the second embodiment shown in FIGS. 5 to 7, a predetermined threshold pressure may be set in accordance with the pressure at which the pre-leakage occurs in the relief valve 5 that is in its non-energized state.

In this second embodiment, similarly to the first embodiment, in addition to a configuration such that the relief valve 5 is energized from the controller 7 to let the pump pressure escape when the pump pressure rises. Then, the setting pressure of the relief valve 5 is set by energizing the relief valve 5 from the controller 7 so that pre-leakage may not be caused by a pump pressure immediately before the energization of the relief valve 5.

That is, as shown in FIG. 5, generally, the relief valve 5 causes an outflow of the working fluid gradually to start (pre-leakage) from pressure immediately before the circuit pressure (system pressure) of the fluid pressure circuit 1 becomes the predetermined setting pressure. In the present embodiment, it is intended to set the energization quantity for setting the setting pressure of the relief valve 5, so that an energy loss due to such pre-leakage does not occur.

The setting pressure of the relief valve 5 at this time may be arbitrarily set as long as it is equal to or higher than a pressure at which the pre-leakage does not occur, but in a case where the energization quantity (input current)-setting pressure characteristic of the relief valve 5 is like an example shown in FIG. 2, for example, a setting pressure lower than a maximum setting pressure P1 is set.

When calibration of the setting pressure is performed, an engine horsepower is set to the maximum output, and further the fluid pressure actuator 3 is put into a maximum load state by the lever, and the energization quantity of the solenoid of the relief valve 5 by the controller 7 is set to a predetermined first energization quantity, similarly to the first embodiment. For example, the use of a boom cylinder as the fluid pressure actuator 3 brings into a state with the lever of being maintained at a position where the boom is raised maximally up to an operating limit, that is, at a position where the boom cylinder is extended to the maximum, that is, a boom lifted stall state.

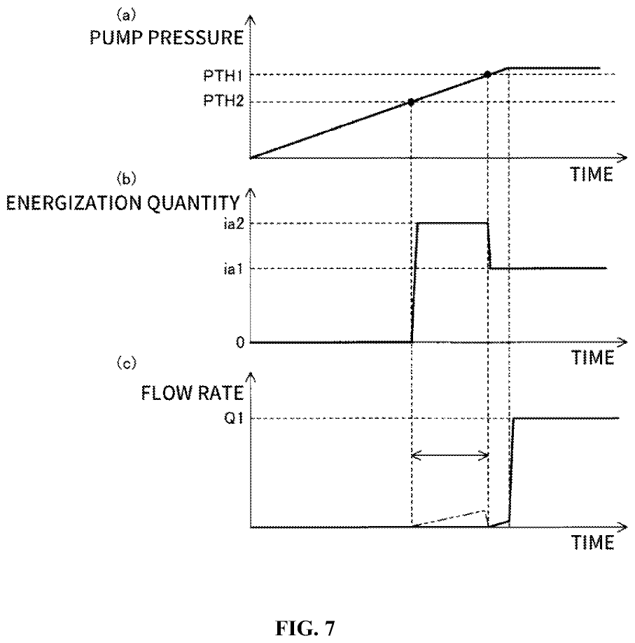

In this state, as an example is shown in FIG. 6, an energization quantity i1 of the relief valve 5 is gradually increased from an predetermined first energization quantity i01 from the controller 7. An energization quantity i1 is recorded when a pump pressure detected by the pressure sensor 6 at a predetermined first set flow rate Q1 of the relief valve 5 becomes a target first pressure PR1. The predetermined first energization quantity i01 may be an arbitrary small energization quantity, but is set to 0, for example.

After that, the energization quantity i1 of the relief valve 5 from the controller 7 is set to the predetermined first energization quantity i01 again, and the energization quantity i1 of the relief valve 5 is gradually increased from the controller 7, then the energization quantity i1 is recorded when the pump pressure detected by the pressure sensor 6 at the predetermined first set flow rate Q1 of the relief valve 5 becomes the target first pressure PR1. This operation is repeated a predetermined number of times, and an average value of the energization quantities i1 recorded for each time is registered in the controller 7 as a first predetermined value ia1 (FIG. 7(b)) corresponding to the relief pressure.

The predetermined first set flow rate Q1 is a maximum flow rate that the pump 2 can discharge at the first pressure PR1, and is a value determined depending on the horsepower curve of the work machine or the like and is a value having variations depending on machines.

Similarly, as an example is shown in FIG. 6, an energization quantity i2 of the relief valve 5 is gradually increased from a predetermined second energization quantity i02 from the controller 7, and an energization quantity i2 is recorded when the pump pressure detected by the pressure sensor 6 at a predetermined second set flow rate Q2 of the relief valve 5 becomes a target second pressure PR2. The predetermined second energization quantity i02 may be the same as or different from the predetermined first energization quantity i0, but in the present embodiment, the energization quantity i2 when the second pressure PR2 is reached is assumed to be larger than the energization quantity i1 when the first pressure PR1 is reached (i1<i2), from the fact that the second pressure PR2 is higher than the first pressure PR1. Thus, by setting the predetermined second energization quantity i02 to be larger than the predetermined first energization quantity i01 or the first predetermined value ia1 (FIG. 7(b)), the time required for calibration can be shortened.

After that, the energization quantity i2 of the relief valve 5 is set to the predetermined second energization quantity i02 again from the controller 7, and the energization quantity i2 of the relief valve 5 is gradually increased from the controller 7, and the energization quantity i2 is recorded when the pump pressure detected by the pressure sensor 6 at the predetermined set flow rate Q2 of the relief valve 5 becomes the target second pressure PR2. This operation is repeated a predetermined number of times, and an average value of the recorded for each time energization quantities i2 is registered in the controller 7 as a second predetermined value ia2 (FIG. 7(b)).

In the present embodiment, the second predetermined value ia2 is set to be larger than the first predetermined value ia1. Either the registration of the first predetermined value ia1 or the registration of the second predetermined value ia2 may come first.

The above calibration described above should be performed before shipping the work machine or the like.

Then, if the pump pressure changes with time, for example, as shown in FIG. 7(a), the controller 7 basically is not energizing the relief valve 5, and while the pump pressure exceeds a predetermined threshold pressure PTH2, the energization quantity of the relief valve 5 is set to the second predetermined value ia2 as shown in FIG. 7(b). This prevents the pre-leakage shown by an alternate long and short dash line in FIG. 7(c) from occurring before the relief valve 5 opens to allow a portion of the working fluid to escape to the tank 4 to protect the fluid pressure circuit 1.

When the pump pressure further increases and exceeds a first predetermined threshold pressure PTH1 as shown in FIG. 7(a), the energization quantity of the relief valve 5 is set to the first predetermined value ia1 as shown in FIG. 7(b). This enables the relief valve 5 to open to allow a part of the working fluid to escape to the tank 4, thereby limiting the system pressure of the fluid pressure circuit 1 to the predetermined first pressure PR1 and suppressing an excessive increase in the system pressure.

As described above, in the present embodiment, when the pump pressure exceeds a predetermined threshold pressure that is lower than the setting pressure of the relief valve 5 that is in its non-energized state, the relief pressure can be easily set by energizing the relief valve 5, and furthermore the relief valve 5 can be non-energized in normal times, and the relief valve 5 can be energized only when the pump pressure reaches a high pressure. Consequently, it is possible to provide the same action effect as the first embodiment that power consumption can be suppressed, for example.

Also, by setting a predetermined threshold pressure in accordance with a pressure at which pre-leakage occurs in the relief valve 5 that is in its non-energized state, energy loss due to the pre-leakage can be suppressed, and further the relief pressure can be prevented from becoming lower than desired resulting from the pre-leakage.

In the present embodiment, the controller 7 sets the energization quantity of the relief valve 5 to the first predetermined value, when the pump pressure exceeds the first predetermined threshold pressure lower than the setting pressure of the relief valve 5 that is in its non-energized state, and the controller 7 sets the energization quantity of the relief valve 5 to the second predetermined value larger than the first predetermined value, when the pump pressure is smaller than the first predetermined threshold pressure and exceeds the second predetermined threshold pressure that is set in accordance with a pressure at which the pre-leakage occurs in the relief valve 5 that is in its non-energized state. By doing so, the relief pressure can be easily set with a minimum energization quantity, while preventing the pre-leakage from occurring by setting the setting pressure higher until immediately before the pump pressure becomes the first predetermined threshold pressure.

In particular, if the setting pressure is set mechanically using a relief valve of two-stage regulation type, regulation is laborious, configuration is complicated as well, and the pressure regulation work is required over a plurality of times. On the other hand, in the present embodiment, laborious regulation is not required, and the configuration is simple, so that the configuration is inexpensive, and the working fluid is less likely to leak.

In each embodiment, the setting pressure of the relief valve 5 that is in its non-energized state may be set mechanically.

Further, three or more predetermined threshold pressures of the pump pressure for energizing the relief valve 5 from the controller 7 may be set. Even when a plurality of threshold pressures is set, not only the energization quantity to the relief valve 5 is controlled from the controller 7, but also different relief pressures can be easily set depending on the operation and mode of the work machine or the like.

### INDUSTRIAL APPLICABILITY

The present invention has industrial applicability for business operators engaged in manufacturing industry, sales industry, or the like of fluid pressure circuits and work machines comprising these circuits.

1. A relief pressure control device configured to control a relief pressure of a fluid pressure circuit, the relief pressure control device comprising:
an electromagnetic relief valve in which a setting pressure is set larger as an energization quantity is larger; and
a controller configured to set at least one relief pressure of a fluid pressure circuit by controlling the energization quantity of the electromagnetic relief valve,
wherein the controller energizes the electromagnetic relief valve, when a pump pressure exceeds a predetermined threshold pressure lower than the setting pressure of the electromagnetic relief valve that is in its non-energized state.

2. The relief pressure control device according to claim 1, wherein the predetermined threshold pressure is set in accordance with a pressure at which pre-leakage occurs in the electromagnetic relief valve that is in its non-energized state.

3. The relief pressure control device according to claim 1, wherein the controller sets the energization quantity of the electromagnetic relief valve to a first predetermined value, when the pump pressure exceeds a first predetermined threshold pressure lower than the setting pressure of the electromagnetic relief valve that is in its non-energized state, and the controller sets the energization quantity of the electromagnetic relief valve to a second predetermined value larger than the first predetermined value, when the pump pressure is smaller than the first predetermined threshold pressure and exceeds a second predetermined threshold pressure that is set in accordance with a pressure at which the pre-leakage occurs in the electromagnetic relief valve that is in its non-energized state.
